(19) United States
(12) Patent Application Publication
(10) Pub. No.: US 2018/0075361 A1
(43) Pub. Date: Mar. 15, 2018

(54) HIDDEN DYNAMIC SYSTEMS

(71) Applicant: HEWLETT-PACKARD ENTERPRISE DEVELOPMENT LP, Houston, TX (US)

(72) Inventors: Xiaofeng Yu, Beijing (CN); Jun Qing Xie, Beijing (CN)

(21) Appl. No.: 15/559,207

(22) PCT Filed: Apr. 10, 2015
(86) PCT No.: PCT/CN2015/076307

§ 371 Date: Sep. 18, 2017

(51) Int. Cl. G06N 7/00; G06F 17/30

(52) U.S. Cl. CPC G06N 7/005; G06F 17/30946

(57) ABSTRACT

Examples relate to hidden dynamic systems. In some examples, a conditional probability distribution for labeling data record segments is defined, where the conditional probability distribution models dependencies between class labels and internal substructures of the data record segments. At this stage, optimal parameter values are determined for the conditional probability distribution by applying a quasi-Newton gradient ascent method to training data, where the conditional probability distribution is restricted to a disjoint set of hidden states for each of the class labels. The conditional probability distribution and the optimal parameter values are used to determine a most probable labeling sequence for the data record segments.

### BACKGROUND

Annotating or labeling observation sequences arises in many applications across a variety of scientific disciplines, most prominently in natural language processing, information extraction, speech recognition, and bio-informatics. Recently, the predominant formalism for modeling and predicting label sequences has been based on discriminative models and variants. Conditional Random Fields (CRFs) are perhaps the most commonly used technique for probabilistic sequence modeling.

### BRIEF DESCRIPTION OF THE DRAWINGS

The following detailed description references the drawings, wherein:

FIG. 1 is a block diagram of an example computing device for analyzing data using hidden dynamic systems;

FIG. 2 is a block diagram of an example computing device in communication with server devices for analyzing data using hidden dynamic systems;

FIG. 3 is a flowchart of an example method for execution by a computing device for analyzing data using hidden dynamic systems; and

FIG. 4 is a graph of example hidden dynamic conditional random fields (HDCRFs).

### DETAILED DESCRIPTION

As detailed above, CRFs are commonly used for probabilistic sequence modeling. Structured data are widely prevalent in the real world, and observation sequences tend to have distinct internal sub-structure and indicate predictable relationships between individual class labels, especially for natural language. For example in the task of noun phrase chunking, a noun phrase begins with a noun or a pronoun and may be accompanied by a set of modifiers. In this example, a noun phrase may contain one or more base noun phrases. In the named entity recognition task, named entities have particular characteristics in their composition. A location name can end with a location salient word but cannot end with any organization salient word. A complex, nested organization name may be composed of a person name, a location name, or even another organization name. Such complex and expressive structures can largely influence predictions. The efficiency of the CRF approach heavily depends on its first order Markov property—given the observation, the label of a token is assumed to depend only on the labels of its adjacent tokens. Further, the CRF approach models the transitions between class labels to enjoy advantages of both generative and discriminative methods capture external dynamics without consideration for internal sub-structure.

In examples described herein, the internal sub-structure in sequence data is directly modeled by incorporating a set of observed variables with additional latent, or hidden state variables to model relevant sub-structure in a given sequence, resulting in a new discriminative framework, Hidden Dynamic Conditional Random Fields (HDCRFs). The model learns the external dependencies by modeling a continuous stream of class labels and learns internal sub-structure by utilizing intermediate hidden states. HDCRFs define a conditional distribution over the class labels and hidden state labels conditioned on the observations, where dependencies between the hidden variables can be expressed by an undirected graph. Such modeling is able to deal with features that can be arbitrary functions of the observations. Efficient parameter estimation and inference can be carried out using standard graphical model algorithms such as belief propagation.

For example in web data extraction from encyclopedic pages such as WIKIPEDIA®, each encyclopedic page has a major topic or concept represented by a principal data record such as “Beijing”. A goal of HDCRFs is to extract all the interested data records such as “Beijing municipality”, “October 28”, “1420”, and “Qing Dynasty”, and assign class labels to these data records. In this example, the class labels can include pre-defined labels such as “person”, “date”, “year”, “organization” labels assigned to each data record and hidden state variables to identify substructures like the relationship between “Beijing” and “municipality” or “Qing” and “Dynasty.” If the substructure between “Beijing” and “municipality” is identified, “Beijing municipality” can be properly labeled as an “organization.” WIKIPEDIA® is a registered trademark of the Wikimedia Foundation, Inc., which is headquartered in San Francisco, Calif.

In some examples, a conditional probability distribution for labeling data record segments is defined, where the conditional probability distribution models dependencies between class labels and internal substructures of the data record segments. Data record segments may be observed data such as content from web pages, text from books, documents, etc. At this stage, optimal parameter values are determined for the conditional probability distribution by applying a quasi-Newton gradient ascent method to training data, where the conditional probability distribution is restricted to a disjoint set of hidden states for each of the class labels. The conditional probability distribution and the optimal parameter values are used to determine a most probable labeling sequence for the data record segments.

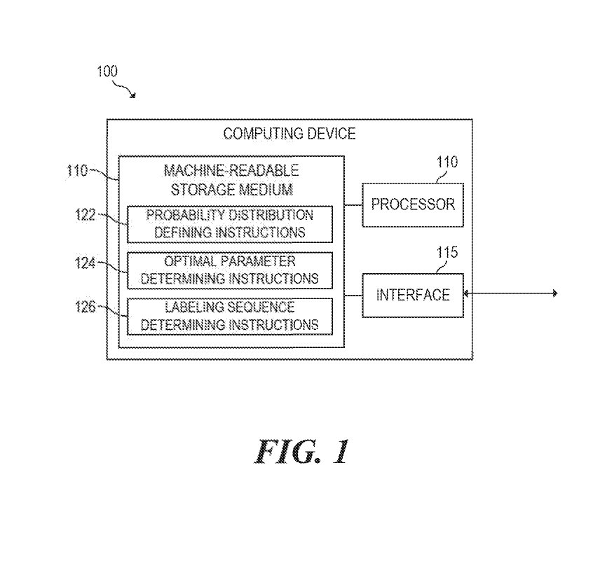

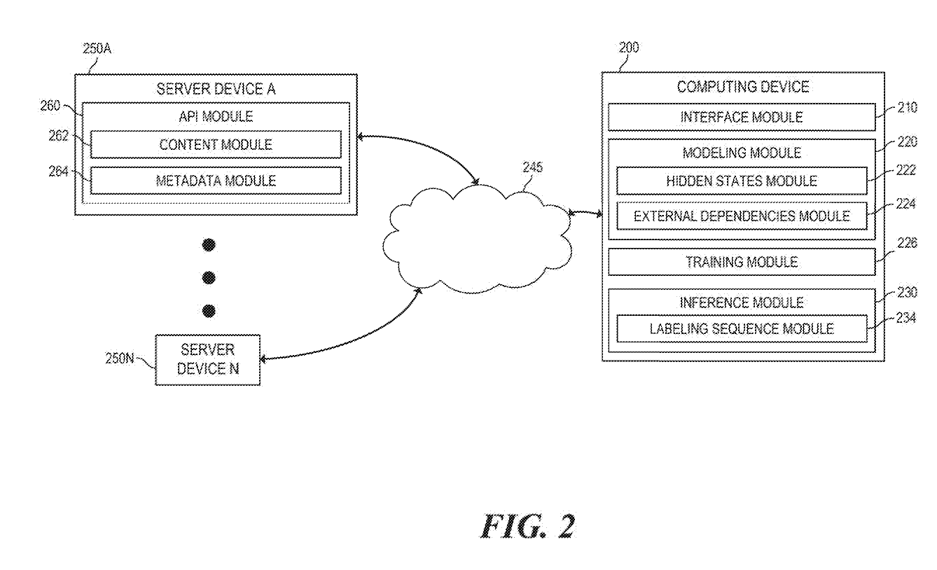

Referring now to the drawings, FIG. 1 is a block diagram of an example computing device 100 for analyzing data using hidden dynamic systems. Computing device 100 may be any computing device capable of accessing server devices, such as server devices 250A, 250N of FIG. 2. In the embodiment of FIG. 1, computing device 100 includes a processor 110, an interface 115, and a machine-readable storage medium 120.

Processor 110 may be central processing unit(s) (CPUs), microprocessor(s), and/or other hardware device(s) suitable for retrieval and execution of instructions stored in machine-readable storage medium 120. Processor 110 may fetch, decode, and execute instructions 122, 124, 126 to enable analyzing data using hidden dynamic systems (e.g., hidden states). As an alternative or in addition to retrieving and executing instructions, processor 110 may include electronic circuits comprising a number of electronic components for performing the functionality of instructions 122, 124, 126.

Interface 115 may include a number of electronic components for communicating with a server device. For example, interface 115 may be an Ethernet interface, a Universal Serial Bus (USB) interface, an IEEE 1394 (Firewire) interface, an external Serial Advanced Technology Attachment (eSATA) interface, or any other physical connection interface suitable for communication with the server device. Alternatively, interface 115 may be a wireless interface, such as a wireless local area network (WLAN) interface or a near-field communication (NFC) interface. In operation, as detailed below, interface 115 may be used to send and receive data to and from a corresponding interface of a server device.

Machine-readable storage medium 120 may be any electronic, magnetic, optical, or other physical storage device that stores executable instructions. Thus, machine-readable storage medium 120 may be, for example, Random Access Memory (RAM), an Electrically-Erasable Programmable Read-Only Memory (EEPROM), a storage drive, an optical disc, and the like. As described in detail below, machine-readable storage medium 120 may be encoded with executable instructions for analyzing data using hidden dynamic systems.

Probability distribution defining instructions 122 define a probability distribution for labeling observation sequences. Suppose X is a random variable over data sequences to be labeled, and Y is a random variable over corresponding label sequences. The distribution defines mappings between an observation sequence X=(x₁, x₂, . . . , x_{T}) and the corresponding label sequence Y=(y₁, y₂, . . . , y_{T}). Each yⱼ is a member of the possible class label set. For each sequence, a vector of sub-structure variables S=(s₁, s₂, . . . , s_{T}) are assumed, which are not observed in training examples and, thus, form a set of hidden variables. Each sⱼ is a member of a finite set S_{yj} of possible hidden states for the class label yⱼ. Suppose S is the set of all possible hidden states of all S_{y} sets. Each sⱼ corresponds to a labeling of xⱼ with some member of S, which may correspond to substructure of the sequence.

Given the above definitions, a hidden dynamic probabilistic model can be defined as follows:

$$p ( Y \vert X ) = {\sum }_{S}^{ } p ( Y \vert S , X ) \cdot p ( S \vert X ) . \qquad ( 1 )$$

By definition, sequences which have any sⱼ [symbol] S_{yj} will obviously have p(Y|S, X)=0, so the model above can be rewritten as:

$$p ( Y \vert X ) = {\sum }_{S \text{:} ∀ {s}_{j} ∈ {S}_{{y}_{j}}}^{ } p ( S \vert X ) \qquad ( 2 )$$

Similar to CRFs, the conditional probability distributions, p(S|X), can take the form:

$$p ( S \vert X ) = \frac{1}{Z ( X )} exp ( {\sum }_{k}^{ } {λ}_{k} \cdot {\sum }_{j = 1}^{T} {f}_{k} ( {s}_{j - 1} , {s}_{j} , X , j ) ) , \qquad ( 3 )$$

where Z(X) is an instance-specific normalization function:

$$Z ( X ) = {\sum }_{S}^{ } exp ( {\sum }_{k}^{ } {λ}_{k} \cdot {\sum }_{j = 1}^{T} {f}_{k} ( {s}_{j - 1} , {s}_{j} , X , j ) ) , \qquad ( 4 )$$

and ƒₖ(sⱼ₋₁, sⱼ, X, j)ₖ₌₁^{K} is a set of real-valued feature functions. Λ={λₖ}ε [symbol] ^{K} is a parameter vector that reflects the confidence of feature functions. Each feature function can be either a transition function tₖ(sⱼ₋₁, sⱼ, X, j) over the entire observation sequence and the hidden variables at positions i and i−1, or a state function sₖ(sⱼ, X, j) depends on a single hidden variable at position i. Note that the model is different from hidden conditional random fields (HCRFs), which model the conditional probability of one class label y given the observation sequence X through:

$$p ( y \vert X ) = \frac{1}{{Z}^{′} ( X )} {\sum }_{S {∈}_{y}}^{ } exp ( λ \cdot f ( y , S , X ) ) , \qquad ( 5 )$$

where the partition function Z′(X) is given by:

$${Z}^{′} ( X ) = {\sum }_{y , S {∈}_{y}}^{ } exp ( λ \cdot f ( y , S , X ) ) . \qquad ( 6 )$$

HDCRFs combine the strengths of CRFs and HCRFs by modeling both external dependencies between class labels and internal substructure. Specifically, the weights A associated with the transition function tₖ(sⱼ₋₁, sⱼ, X, j) model both the internal sub-structure and external dependencies between different class labels. Weights associated with a transition function for hidden states that are in the same subset S_{yj} model the substructure patterns while weights associated with the transition functions for hidden states from different subsets will model the external dependencies between labels.

Optimal parameter determining instructions 124 determine optimal parameters for probability distribution. Given some training data consist of n labeled sequences D=(X₁, Y₁), (X₂, Y₂), . . . , (Xₙ, Yₙ), the parameters Λ={λₖ} are set to maximize the conditional log-likelihood. Following previous work on CRFs, the following objective function can be used to estimate the parameters:

$$L ( Λ ) = {\sum }_{i = 1}^{n} log {P}_{Λ} ( {Y}_{i} \vert {X}_{i} ) . \qquad ( 7 )$$

To avoid over-fitting, log-likelihood can be penalized by a prior distribution over parameters that provide smoothing to help with sparsity in the training data. A commonly used prior is a zero-mean (with variance σ²) Gaussian. With a Gaussian prior, log-likelihood is penalized as follows:

$$L ( Λ ) = {\sum }_{i = 1}^{n} log {P}_{Λ} ( {Y}_{i} \vert {X}_{i} ) - {\sum }_{k = 1}^{K} \frac{{λ}_{k}^{2}}{2 {σ}^{2}} \qquad ( 8 )$$

Structural constraints can be encoded with an undirected graph structure, where the hidden variables {s₁, s₂, . . . , s_{T}} correspond to vertices in the graph. To ensure the training and inference remains tractable, the model can be restricted to have disjoint sets (i.e., a set that contains no elements in common) of hidden states associated with each class label. A quasi-Newton gradient ascent method can be used to search for the optimal parameter values, Λ*=arg max_{Λ} L(Λ), under this criterion.

$$\begin{matrix}∀ Y ∈ y , j ∈ 1 … T , a ∈ S , \\ P ( {s}_{j} = a \vert Y , X ) = {\sum }_{S : {s}_{j} = a} P ( S \vert Y , X ) , & ( 9 ) \\ ∀ Y ∈ y , j , k ∈ 1 … T , a , b ∈ S , \\ P ( {s}_{j} = a , {s}_{k} = b \vert Y , X ) = {\sum }_{S : {s}_{j} = a , {s}_{k} = b}^{ } P ( S \vert Y , X ) , & ( 10 )\end{matrix}$$

where P(sⱼ=a|Y,X) and P(sⱼ=a, sₖ=b|Y,X) are marginal distributions over individual variables sⱼ or pairs of variables {sⱼ, sₖ} corresponding to edges in the graph. The gradient of L( [symbol] ) can be defined in terms of these marginal distributions and can therefore be calculated efficiently.

We first consider derivatives with respect to the parameters λₖ associated with a state function sₖ. Taking derivatives results in:

$$\begin{matrix}\frac{\partial L ( Λ )}{\partial {λ}_{k}} = {\sum }_{S} P ( S \vert Y , X ) {\sum }_{j = 1}^{T} {s}_{k} ( {s}_{j} , X , j ) - \\ {\sum }_{{Y}^{′} , S} P ( {Y}^{′} , S \vert X ) {\sum }_{j = 1}^{T} {s}_{k} ( {s}_{j} , X , j ) \\ = {\sum }_{j , a} P ( {s}_{j} = a \vert Y , X ) {s}_{k} ( j , a , X ) - \\ {\sum }_{{Y}^{′} , j , a} P ( {s}_{j} = a , {Y}^{′} \vert X ) {s}_{k} ( j , a , X )\end{matrix} \qquad ( 11 )$$

It shows that

$$\frac{\partial L ( Λ )}{\partial {λ}_{k}}$$

can be expressed in terms of components P(sⱼ=a|X) and P(Y|X), which can be computed using belief propagation.

For derivatives with respect to the parameters λᵢ corresponding to a transition function tᵢ, a similar calculation provides:

$$\frac{\partial L ( Λ )}{\partial {λ}_{l}} = {\sum }_{j , k , a , b} P ( {s}_{j} = a , {s}_{k} = b \vert Y , X ) {t}_{l} ( j , k , a , b , X ) - {\sum }_{{Y}^{′} , j , k , a , b} P ( {s}_{j} = a , {s}_{k} = b , {Y}^{′} \vert X ) {t}_{l} ( j , k , a , b , X ) \qquad ( 12 )$$

hence

$$\frac{\partial L ( Λ )}{\partial {λ}_{k}}$$

can also be expressed in terms of expressions (e.g., the marginal probabilities P(sⱼ=a, sₖ=b|Y,X)) that can be computed efficiently using belief propagation. Gradient ascent can be performed with the limited-memory quasi-Newton BFGS optimization technique.

Labeling sequence determining instructions 126 determine a labeling sequence for observation data (e.g., data record segments). Given a new test sequence X, the most probable labeling sequence Y* can be estimated that maximizes the conditional model:

$${Y}^{*} = arg {max}_{Y} P ( Y \vert X , {Λ}^{*} ) \qquad ( 13 )$$

where the parameters [symbol] are learned via a training process. Assuming each class label is associated with a disjoint set of hidden states, equation (13) can be rewritten as:

$${Y}^{*} = arg {max}_{Y} {\sum }_{S : ∀ {s}_{j} ∈ {S}_{{y}_{j}}} P ( Y \vert X , {Λ}^{*} ) \qquad ( 14 )$$

The marginal probabilities P(sⱼ=a|X, [symbol] *) can be computed for all possible hidden states aεS to estimate the label yⱼ*. These marginal probabilities may then be summed according to the disjoint sets of hidden states S_{yj}, and the label associated with the optimal set can be selected. As discussed in the previous subsection, these marginal probabilities can also be computed efficiently using belief propagation. For example, the above maximal marginal probabilities approach can be used to estimate the sequence of labels because it minimizes error.

FIG. 2 is a block diagram of an example computing device 200 for analyzing data using hidden dynamic systems. Computing device 200 may be, for example, a computing device, a desktop computer, a rack-mount server, or any other computing device suitable for execution of the functionality described below. Computing device 200 is in communication with server devices 250A, 250N via a network 245.

In the embodiment of FIG. 2, computing device 200 includes interface module 210, modeling module 220, training module 226, and inference module 230. While computing device 200 may include a number of modules 210-234. Each of the modules may include a series of instructions encoded on a machine-readable storage medium and executable by a processor of computing device 200. In addition or as an alternative, each module may include one or more hardware devices including electronic circuitry for implementing the functionality described below.

Interface module 210 may manage communications with the server devices 250A, 250N. Specifically, the interface module 210 may initiate connections with the server devices 250A, 250N and then send or receive observation data (e.g., data record segments) to/from the server devices 250A, 250N.

Modeling module 220 generates hidden dynamic probabilistic models for analyzing data. Specifically, modeling module 220 may generate a probabilistic model as described above with respect to FIG. 1. Hidden states module 222 of modeling module 220 can manage a set of hidden states to be used in probabilistic functions. The hidden states can be used to model the internal substructure of an observation sequence. External dependencies module 224 of modeling module 220 models external dependencies between class labels and the internal substructure. Weights associated with a transition function for hidden states that are in the same subset model the sub-structure patterns, while weights associated with the transition functions for hidden states from different subsets will model the external dependencies between labels.

Training module 226 is to estimate parameters of the probabilistic model. Specifically, training module 226 uses training data to maximize the conditional log-likelihood function.

Analysis module 230 is to determine the most probably labeling sequence for observation data (e.g., data record segments). Specifically, labeling sequence module 234 of analysis module 230 computes marginal probabilities for all possible hidden states to estimate a label. Then these marginal probabilities are summed according to the disjoint sets of hidden states and the label associated with the optimal set is chosen.

Server devices 250A, 250N may be any servers accessible to computing device 200 over a network 245 that is suitable for executing the functionality described below. As detailed below, each server device 250A, 250N may include a series of modules 260-264 for providing web content.

API module 260 is configured to provide access to observation data of server device A 250A. Content module 262 of API module 260 is configured to provide the observation data as content over the network 245. For example, the content can be provided as HTML pages that are configured to be displayed in web browsers. In this example, server computer device 200 obtains the HTML pages from the content module 262 for processing as observation data as described above.

Metadata module 264 of API module 260 manages metadata related to the content. The metadata describes the content and can be included in, for example, web pages provided by the content module 262. In this example, keywords describing various page elements can be embedded as metadata in the web pages.

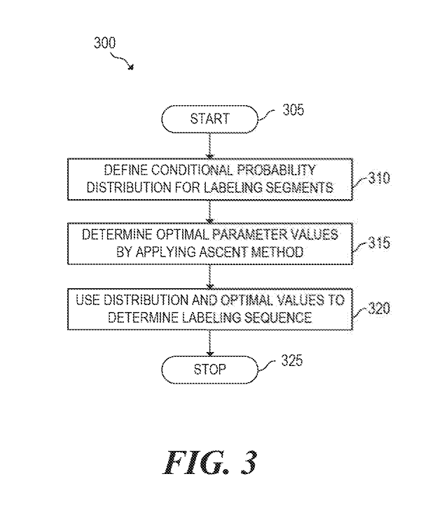

FIG. 3 is a flowchart of an example method 300 for execution by a computing device 100 for analyzing data using hidden dynamic systems. Although execution of method 300 is described below with reference to computing device 100 of FIG. 1, other suitable devices for execution of method 300 may be used, such as computing device 200 of FIG. 2. Method 300 may be implemented in the form of executable instructions stored on a machine-readable storage medium, such as storage medium 120, and/or in the form of electronic circuitry.

Method 300 may start in block 305 and continue to block 310, where computing device 100 generates a hidden dynamic probabilistic model for analyzing data using hidden dynamic systems. The probabilistic model can include hidden states for modeling the internal substructure of an observation sequence. Further, weights associated with a transition function for hidden states that are in the same subset model the sub-structure patterns, while weights associated with the transition functions for hidden states from different subsets will model the external dependencies between labels.

In block 315, computing device 100 determines optimal parameters of the probabilistic model by applying an ascent method. In block 320, computing device 100 uses the probabilistic model and the optimal parameters to determine the most probably labeling sequence for observation data. Method 300 may then continue to block 325, where method 300 may stop.

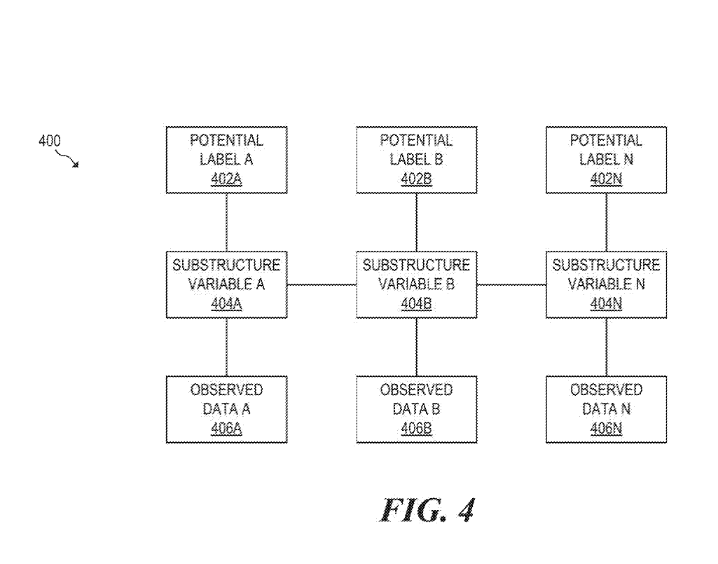

FIG. 4 is a graph 400 of example hidden dynamic conditional random fields (HDCRFs). The graph 400 shows an observation sequence 406A-406N with potential labels 402A-402N. As shown, hidden variables 404A-404N model the internal substructure of observation sequence 406A-406N. In this example, only links with the current observation set is shown, but long range dependencies can also possible.

In the example graph 400, each transition function defines an edge feature while each state function defines a node feature as described above with respect to FIG. 1. All the observed data 406A-406N respect the structure of graph in that no observed data depends on more than two of the hidden variables 404A-404N, and if a feature does depend on two hidden variables, there should be a corresponding edge in the graph. Example graph 400 can be encoded arbitrarily to capture domain specific knowledge such as the internal sub-structure.

The foregoing disclosure describes a number of examples for analyzing data using hidden dynamic systems. In this manner, the example disclosed herein improves labeling of observation data by modeling both external dependencies between the class labels and internal substructure of the observation data.

We claim:

1. A server computing device for analyzing data using hidden dynamic systems, the computing device comprising:
a processor to:
define a conditional probability distribution for labeling a plurality of data record segments, wherein the conditional probability distribution models dependencies between class labels and internal substructures of the plurality of data record segments;
determine optimal parameter values for the conditional probability distribution by applying a quasi-Newton gradient ascent method to training data, wherein the conditional probability distribution is restricted to a disjoint set of hidden states for each of the class labels; and
use the conditional probability distribution and the optimal parameter values to determine a most probable labeling sequence for the plurality of data record segments.

2. The server computing device of claim 1, wherein the conditional probability distribution is defined as
$$p ( S \vert X ) = \frac{1}{Z ( X )} exp ( {\sum }_{k} {λ}_{k} \cdot {\sum }_{j = 1}^{T} {f}_{k} ( {s}_{j - 1} , {s}_{j} , X , j ) ) ,$$
and wherein X is an observation sequence, Y is a potential labeling sequence, S is a vector of sub-structure variables, and λₖ is a confidence parameter.

3. The server computing device of claim 2, wherein the quasi-Newton gradient ascent method is performed using a Gaussian prior defined as
$$L ( Λ ) = {\sum }_{i = 1}^{n} log {P}_{Λ} ( {Y}_{i} \vert {X}_{i} ) - {\sum }_{k = 1}^{K} \frac{{λ}_{k}^{2}}{2 {σ}^{2}} ,$$
and wherein [symbol] is a set of parameters that includes the confidence parameter.

4. The server computing device of claim 2, wherein the plurality of data segments are applied to the conditional probability distribution to determine a plurality of marginal probabilities for each of the class labels.

5. The server computing device of claim 4, wherein the plurality of marginal probabilities are summed according to the disjoint sets of hidden states to determine the most probably labeling sequence.

6. The server computing device of claim 2, wherein the confidence parameters and a transition function fₖ model dependencies between the class labels and the internal substructures.

7. A method for analyzing data using hidden dynamic systems, comprising:
defining a conditional probability distribution for labeling a plurality of data record segments, wherein the conditional probability distribution models dependencies between class labels and internal substructures of the plurality of data record segments;
determining optimal parameter values for the conditional probability distribution by applying a quasi-Newton gradient ascent method to training data, wherein the conditional probability distribution is restricted to a disjoint set of hidden states for each of the class labels; and
using the conditional probability distribution and the optimal parameter values to determine a most probable labeling sequence for the plurality of data record segments, wherein the plurality of data segments are applied to the conditional probability distribution to determine a plurality of marginal probabilities for each of the class labels.

8. The method of claim 7, wherein the conditional probability distribution is defined as
$$p ( S \vert X ) = \frac{1}{Z ( X )} exp ( {\sum }_{k} {λ}_{k} \cdot {\sum }_{j = 1}^{T} {f}_{k} ( {s}_{j - 1} , {s}_{j} , X , j ) ) ,$$
and wherein X is an observation sequence, Y is a potential labeling sequence, S is a vector of sub-structure variables, and λₖ is a confidence parameter.

9. The method of claim 8, wherein the quasi-Newton gradient ascent method is performed using a Gaussian prior defined as
$$L ( Λ ) = {\sum }_{i = 1}^{n} log {P}_{Λ} ( {Y}_{i} \vert {X}_{i} ) - {\sum }_{k = 1}^{K} \frac{{λ}_{k}^{2}}{2 {σ}^{2}} ,$$
and wherein Λ is a set of parameters that includes the confidence parameter.

10. The method of claim 9, wherein the plurality of marginal probabilities are summed according to the disjoint sets of hidden states to determine the most probably labeling sequence.

11. The method of claim 8, wherein the confidence parameters and a transition function fₖ model dependencies between the class labels and the internal substructures.

12. A non-transitory machine-readable storage medium encoded with instructions executable by a processor for analyzing data using hidden dynamic systems, the machine-readable storage medium comprising instructions to:
define a conditional probability distribution for labeling a plurality of data record segments, wherein the conditional probability distribution models dependencies between class labels and internal substructures of the plurality of data record segments;
determine optimal parameter values for the conditional probability distribution by applying a quasi-Newton gradient ascent method to training data, wherein the conditional probability distribution is restricted to a disjoint set of hidden states for each of the class labels; and
use the conditional probability distribution and the optimal parameter values to determine a most probable labeling sequence for the plurality of data record segments, wherein the plurality of data segments are applied to the conditional probability distribution to determine a plurality of marginal probabilities for each of the class labels.

13. The non-transitory machine-readable storage medium of claim 12, wherein the conditional probability distribution is defined as
$$p ( S \vert X ) = \frac{1}{Z ( X )} exp ( {\sum }_{k} {λ}_{k} \cdot {\sum }_{j = 1}^{T} {f}_{k} ( {s}_{j - 1} , {s}_{j} , X , j ) ) ,$$
and wherein X is an observation sequence, Y is a potential labeling sequence, S is a vector of sub-structure variables, and λₖ is a confidence parameter.

14. The non-transitory machine-readable storage medium of claim 13, wherein the quasi-Newton gradient ascent method is performed using a Gaussian prior defined as
$$L ( Λ ) = {\sum }_{i = 1}^{n} log {P}_{Λ} ( {Y}_{i} \vert {X}_{i} ) - {\sum }_{k = 1}^{K} \frac{{λ}_{k}^{2}}{2 {σ}^{2}} ,$$
and wherein [symbol] is a set of parameters that includes the confidence parameter.

15. The non-transitory machine-readable storage medium of claim 14, wherein the plurality of marginal probabilities are summed according to the disjoint sets of hidden states to determine the most probably labeling sequence.
